(19) United States
(12) Patent Application Publication
(10) Pub. No.: US 2001/0049639 A1
(43) Pub. Date: Dec. 6, 2001

(54) System and method for production and dispatch of virtual photographic correspondence cards

(76) Inventor: Bertrand Sapin-Lignieres, Cenac Et Saint - Julien (FR)

Correspondence Address: YOUNG & THOMPSON, 745 SOUTH 23RD STREET 2ND FLOOR, ARLINGTON, VA, 22202

(21) Appl. No.: 09/864,490

(22) Filed: May 25, 2001

Related U.S. Application Data
(60) Provisional application No. 60/227,013, filed on Aug. 23, 2000.

(30) Foreign Application Priority Data
May 25, 2000 (FR) 00 06703

(51) Int. Cl. G06F 17/60

(52) U.S. Cl. 705/26; 705/1

(57) ABSTRACT

The invention relates to a system for production and dispatch of virtual photographic correspondence cards comprising at least one sender network (2, 3) and a recipient network (4, 5) for transmission of digital data, at least one interactive terminal (14, 16, 18) which has computer resources, means for taking shots, means for payment, means for connection to the sender network (15, 17, 19) and a human interface, designed to permit taking of a shot and generation of digital photographic data, digital payment data and digital client data, at least part of the client data and photographic data forming the virtual card, at least one centralising computer device (1) for automatic processing of the said data, which is connected to the sender (2, 3) and recipient (4, 5) networks, and can gather, via the sender network (2, 3), at least part of the data stored in each interactive terminal, record the data gathered, and address at least part of these data (including the virtual card) via the recipient network (4, 5).

The invention relates to a system for production and dispatch of virtual photographic correspondence cards comprising at least one centralising computer device, which is connected by means of at least one digital data transmission network, to one or a plurality of interactive terminals for taking shots. It also extends to a method for production of virtual photographic correspondence cards and for dispatch of the cards created.

Throughout the description, the term “correspondence card” designates a means for transmission of a message to a recipient. In particular, the form, the support, the means for dispatch and the content of a correspondence card can be different, i.e. the card can be physical or virtual (i.e. formed solely by a computer or electronic record); it can contain a photograph (the card is then known as a photographic correspondence card), and/or an image or a drawing (so-called illustrated correspondence card), and/or an alphanumerical message, etc. Throughout the remainder of the document, the term “virtual card” designates a virtual photographic correspondence card.

The best known and most widely-used type of correspondence card is the postcard. The postcard is a correspondence card which is illustrated or photographic, and thus comprises a photograph or an image. It also comprises a message, an address and a stamp as payment for its dispatch by post. It is formed by a physical support, generally made of reinforced paper or cardboard, and is dispatched via the postal network. It has the following disadvantages: it is not personalised by the photograph of the sender; and its dispatch is not immediate, can be lengthy, and requires a series of actions by the sender before the card is dispatched, which are not necessarily carried out in a single location (purchasing the card, writing the message, purchasing a stamp, putting the card into a postbox, etc).

U.S. Pat. No. 5,343,386 describes a photographic booth comprising mainly a video camera, a central computer unit and a payment device, and which allows a user of the booth, known as the client, to paste his portrait, taken by the said camera, onto a background pre-selected by him from an image bank previously recorded in the central unit. The backgrounds proposed can be tourist sites of the region, inter alia. The photograph obtained is a superimposition of the portrait of the client and of the background which he has previously selected. It is printed on a paper support in the form of a postcard which is pre-printed overleaf (location for the address, the stamp, etc), by a printing device situated in the booth. The postcard obtained is supplied to the client immediately. The possibilities for framing the portrait of the client are relatively limited (only his head and upper part of the body are shown in the photograph). The booth is preferably closed, and is provided with artificial lighting. The postcard created by the booth is then completed by hand by the sender (address, message etc), and is sent to its recipient by the conventional postal network.

DE 198 49 759 describes a device for sending electronic mail, comprising: an information acquisition device (camera, scanner, data reader) in order to produce or read a photograph of a pre-determined design, a data acquisition device (keyboard, touch screen, microphone) in order to acquire orders and/or text data, a display device (screen, printer), a data processing device (computer), and a data transmission device (connection by cable, radio connection, optical connection to a data or telephone line network). The data processing device produces a virtual correspondence card from the digitised photograph, and from certain text data. The card is transmitted directly to its recipient by electronic mail via the Internet, by means of a direct connection or a unit for connection (modem, radio) to the telephone network, or to an Internet network node.

In this context, the object of the present invention is to provide an economically viable solution, which makes it possible to produce an original, personalised photographic correspondence card, and to transmit the said card quickly (reduction of number of steps and time necessary to transmit a conventional postcard), and at a cost which is competitive in relation to the conventional postal channel and to the device described by DE 198 49 759.

The object of the invention is to propose a system which is simply, centralised, and designed to control and manage in parallel a plurality of terminals for production of virtual correspondence cards, dispersed in a given geographical territory.

A further objective of the invention is to propose a device which makes it possible to take an instantaneous photograph of one or a plurality of users in front of a real, live site (tourist sites such as monuments, lively streets, well-known restaurants or shops etc, landscapes or exceptional views etc), in order to create a photographic correspondence card which shows that the user has visited the place in question.

The object of the invention is also to allow the user considerable freedom in framing the photograph, so as to enable him to produce the photograph he requires.

For this purpose, the invention relates to a system for production and dispatch of virtual photographic correspondence cards, known as virtual cards, comprising at least one interactive terminal, which is located at a site accessible to a user, known as the client, of the said terminal, each interactive terminal comprising computer resources, means for taking shots, means for payment, means for connection to a digital data transmission network, and a human interface, the said means, resources and interface as a whole being designed to permit taking of a shot, and to generate and store digital data relating to the shot, known as photographic data, digital data relating to the payment, known as payment data, and digital data relating to information provided by the client, by means of the human interface, known as client data, at least part of the client data and photographic data forming the virtual card (certain client and/or photographic data, such as associated data which are connected and are necessary for the functioning of the means for taking shots and/or of the human interface—management of the said means and interface, control keys etc.—, and/or are necessary for transmission of the virtual card, and are not involved in the composition of the said card),

the said system being characterised in that it comprises:

at least one digital data transmission network, known as the sender network, to which each interactive terminal can be connected;

at least one digital data transmission network, known as the recipient network;

the said sender and recipient networks being designed to be able to transmit digital photographs or images and/or text and/or sound; and

at least one centralising computer device, for automatic processing of the data stored by each terminal, known as the centralising device, comprising computer resources and means for connection to the sender and recipient networks, which, via the sender network, can receive at least some of the photographic data, the client data and the payment data (and in particular those which form the virtual card) stored in each interactive terminal, record the data received, and address at least part of them (including, for example, the virtual card, certain payment data which relate to payments by bank card, and are necessary for processing of the data by the banks concerned, with the exception of operating data such as data for identification of the various transmissions etc), via the recipient network.

It should be noted that a “shot” means: either an instantaneous photograph, or a continuous film with a short duration (in this case the means for taking a shot comprise a video camera) of the site which extends opposite the means for taking a shot (including the user of the terminal, if the user so wishes).

The sender and recipient networks can be different, intersected or combined. The sender network is preferably a specific network which can be accessed only by each terminal and centralising device, and the recipient network is preferably, at least partially, a public network such as the Internet network. These networks comprise cabled data transmission means (telephone lines, other electric cables, optical fibres etc), and/or wireless transmission means (radiofrequency, radio, satellite etc). The means for connection to the sender network of the interactive terminals and the means for connection to the sender and recipient networks of the centralising device(s) are adapted to the data transmission means to which they are connected, i.e. modulator-demodulator means (modem) in the case of an analogue telephone line (switched telephone network), means for routing in the case of cabled digital data transmission means, and transmission/reception antenna for radio and/or radiofrequency and/or satellite waves, in the case of wireless transmission means.

The virtual photographic correspondence card produced by the terminal is thus transmitted to its recipient by electronic mail for example, via the centralising device and the sender and recipient networks, the electronic address of the recipient being supplied by the client by means of the human interface. The said card can also be displayed on an Internet site with coded access for a given time, as will be explained hereinafter.

Advantageously and according to the invention, the system comprises a plurality of interactive terminals, which can be close to one another, or can be distributed throughout the entire surface of a region or of the earth. They are preferably installed in tourist sites (opposite monuments or famous streets, for example) or in exceptional landscapes. The outer aesthetic form of the terminal can vary according to the site (reproduction in miniature of the monument in question, or of a person associated with the said monument, for example). As far as possible, the appearance selected should attract the attention of passersby, or on the other hand blend into the environment, if the latter is protected.

Advantageously and according to the invention, the means for taking shots of at least one interactive terminal are fitted on the said terminal such that the client located in the vicinity of the terminal in a pre-determined space, is in the field of vision of the said means. The latter are optionally and preferably mobile, and can be oriented by means for adjustment which are accessible to the client, and are designed to make at least part of the said means for taking shots pivots horizontally and vertically. According to an advantageous embodiment, the means for taking shots comprise a digital video camera.

Advantageously and according to the invention, the human interface of at least one interactive terminal comprises an alphanumerical keyboard and/or a touch screen, for input of the client data. It can also comprise a sound-recording device, for acquisition of client data known as client sound data, at least one centralising device being designed to receive part of the said data via the sender network, to record the client sound data acquired, and to address at least part of them via the recipient network. Throughout the description, the term “client data” designates equally well client sound data or client data supplied by any other means of the human interface, which make it possible to acquire data. It should be noted that the client sound data can be recorded in the form of text, in .txt files for example (if the interactive terminal has the necessary means for conversion), and/or in the form of digital sound data recorded in .wav files for example. This last characteristic allows the client to transmit a vocal and/or sound accompaniment message to the recipient of the virtual card.

The human interface also advantageously comprises a display screen and/or a sound-emission device, for communication of instructions or information to the client, when the interactive terminal is used.

Advantageously and according to the invention, the human interface of at least one interactive terminal comprises means for printing at least part of the payment data and/or the client data, for immediate distribution of a ticket to the client. The payment data and the client data printed comprise for example the amount, the date, the time and the place of payment, the electronic address of the recipient of the virtual card, and/or optionally the address of the site on which the virtual card is displayed for a given time, as well as a code for access to the said site.

According to a preferred embodiment of the invention, the means for payment of at least one interactive terminal, and in particular of all the terminals, comprise a bank card reading device, at least one centralising device being designed to transmit at least part of the payment data gathered to a bank card processing centre and/or to the banks concerned. As a variant or in combination, the means for payment comprise a device which receives means for payment other than bank cards, and in particular coins and/or bank notes.

According to one embodiment of the invention, the human interface and/or the means for taking shots of at least one interactive terminal are designed to remain active between two usages of the said terminal. If the terminal is equipped with a digital video camera and a display screen, the camera then films continuously the subject towards which it is turned, and the display screen emits continuously the images filmed. Passers-by are attracted by the moving images emitted, and on which they appear. According to another embodiment, the interactive terminal comprises sensor means which are designed to detect any movement in a given perimeter in the vicinity of the terminal, the means for taking shots and/or the human interface of the said terminal being designed to be active or on standby, between two usages of the said terminal, under the control of the sensor means, according to the movements detected by the said means. Thus, detection of a person passing in the vicinity of the terminal triggers activation of the camera, which films the subject towards which it is turned, and in particular the said person, and transmits the images filmed to the display screen. The gaze of the passer-by is then drawn by the sudden appearance of an image on the display screen.

Advantageously and according to the invention, at least one centralising device comprises:

an internal digital data transmission network, known as the local network, which is designed to be able to transmit digital photographs or images and/or text and/or sound;

at least one computer, known as an intermediate computer, comprising means for connection to the sender network, means for connection to the local network, and a central unit which is provided with software and specific programmes designed to make it possible to receive, via the sender network, and to transmit to a computer known as the central computer, via the local network, at least part of the photographic data, the client data and the payment data stored in a series of pre-determined interactive terminals;

a central computer, comprising means for connection to the recipient network, means for connection to the local network, and a central unit which is provided with specific software and programmes designed to make it possible to receive the data transmitted by each intermediate computer, and to address at least part of the said data via the recipient network, according to transmission protocols determined according to the recipients of the said data. Advantageously and according to the invention, the central computer of the centralising device comprises peripheral means which form a human interface, such as a screen and a printer.

The invention extends to a method for production and dispatch of virtual photographic correspondence cards, implemented in a system according to the invention, as previously described. A method according to the invention comprises:

a step for production of the virtual card by an interactive terminal, comprising:

recording, in the form of client data, of a destination of the virtual card, the said destination being supplied by a client of the terminal by means of the human interface;

recording of payment data, generated by the means for payment, further to payment for the virtual card by the client, by means of the said means for payment;

taking of a shot, according to a process comprising a countdown time before the shot is taken, a shot by the means for taking a shot, and recording of photographic data generated by the shot;

a step of dispatch of the virtual card, in which:

at least part of the client data and the photographic data is transmitted, via the sender network, to the centralising device;

the data received by the said device are recorded, at least part of the said data forming the virtual card; and

the virtual card is addressed, via the recipient network, according to the destination provided by the client.

It should be noted that the virtual card is preferably produced under the control of the means for payment: in this case, the process for taking the shot is triggered by the means for payment, further to payment for the virtual card by the client.

Advantageously and according to the invention, if the system used comprises at least one interactive terminal which has means for recording sound, the method for production and dispatch of virtual cards comprises:

storage of client sound data generated by recording of sound during production of the virtual card;

transmission to the centralising device, via the sender network, of at least part of the client sound data;

receipt and recording of the said data by the centralising device, at least part of the client sound data received forming a vocal and/or sound message to accompany the virtual card; and

dispatch to the recipient of the virtual card, via the recipient network, of the vocal and/or sound message, as an integral part of the said virtual card.

Thus, by means of the invention, the photographic correspondence card can be personalised not only by the photograph of its sender, but also by his voice, since he can accompany the virtual card by a sound message.

Advantageously and according to the invention, at least part of the payment data is also transmitted, via the sender network, to the centralising device, and is recorded by the said device.

Advantageously and according to the invention, the client data and/or the photographic data and/or the payment data generated by the terminal during production of the virtual card are compressed and/or coded before being transmitted to the centralising device, the said data being decompressed and/or decoded after being received by the centralising device.

Advantageously and according to the invention, the centralising device verifies the intactness of the transmission of client data and/or photographic data and/or payment data gathered, by carrying out procedures for checking of errors and procedures for partial or total re-running of the transmissions interrupted.

Advantageously and according to the invention, the centralising device classifies the digital data gathered according to their nature (text, image, sound), and labels the said data according to parameters relating to their terminal of origin and their transmission to the centralising device (name of the terminal, order number in the said terminal, numerical identifier of the transfer operation, etc).

Advantageously and according to the invention, the client data and/or the photographic data and/or the payment data for each interactive terminal, transmitted to the centralising device, are erased from the memory of the said terminal, as soon as they have finished being transmitted, for example after verification and recording of the said data by the centralising device.

Advantageously and according to the invention, at least art of the payment data gathered by the centralising device relative to payments made by bank card at the interactive terminals comprising a suitable payment device, is addressed, via the recipient network, to a bank card processing centre and/or to the banks concerned. Virtual cards corresponding to payment data which are not considered valid by the bank card processing centre are not addressed to their recipient, and the photographic data, the client data and the payment data concerned are erased from the centralising device. According to one embodiment of the invention, only the payment data considered valid by the bank card processing centre are addressed to the banks concerned. According to another embodiment of the invention, all the payment data are transmitted to the banks concerned, including payment data which are not considered valid by the bank card processing centre. Finally, according to another embodiment, the payment data received by the centralising device are transmitted directly to the banks concerned, without prior transmission to a bank card processing centre.

Advantageously and according to the invention, when the interactive terminal comprises means for printing of data, at least part of the client data and/or the payment data is printed onto a ticket issued immediately to the client.

According to an advantageous embodiment of the invention, the transmission of the various items of data to the centralising device is initiated and carried out as follows: the centralising device triggers periodically and automatically a connection to the sender network, for interrogation of each interactive terminal, and gathers remotely in batches, via the said sender network, at least art of the client data, the photographic data and/or the payment data which may be detected (the said centralising device having computer means which are designed to carry out the preceding operations). In a conventional client-server architecture, using for example a switched telephone network as a sender network, the interactive terminals are server machines on standby for a call, whereas the centralising device is a client machine.

According to another embodiment of the invention, transmission of the data between the terminals and the centralising device is initiated and carried out as follows: each interactive client terminal triggers periodically a connection to the sender network, in order to send to the centralising server device at least part of the client data, photographic data and/or payment data which it has stored.

Advantageously and according to the invention, the transmission of miscellaneous data to their respective recipients by the centralising device is initiated and carried out as follows: the centralising device triggers periodically and automatically a connection to the recipient network, for dispatch in batches of the virtual cards gathered, to their recipient, and/or for dispatch in batches of the payment data relative to payments made by bank card to a bank card processing centre, and/or to the banks concerned.

The virtual cards are thus dispatched in batches. The terminals and the centralising device are connected only selectively to the data transmission networks, which makes it possible to reduce considerably the operating costs of the system.

Advantageously and according to the invention, when the centralising device comprises a central computer and a plurality of intermediate computers:

each intermediate computer triggers periodically and automatically a connection to the sender network, interrogates consecutively each terminal in the series of pre-determined interactive terminals, which it controls, gathers remotely, verifies, classifies and labels at least part of the client data, the photographic data and the payment data detected in the said terminals, and transmits the data gathered remotely to the central computer, via the local network; and

the central computer triggers periodically and automatically a connection to the recipient network, and addresses in batches to their recipient the virtual cards gathered, and/or addresses in batches to a bank card processing centre and/or to the banks concerned the payment data gathered relative to payments made by bank card.

Advantageously and according to the invention, when the recipient network used by the system is at least partially the Internet network, the virtual card is installed for a specific time, with the agreement of the client, on an Internet site. This site is preferably a site with coded access restricted solely to the client of the interactive terminal, sender of the said virtual card. This option is proposed by the interactive terminal to the client, who accepts or rejects it. The response by the client is stored in the client data. In the event of acceptance, the terminal supplies the client with the address of the site, and the access code. This information is for example printed on a ticket issued to the client upon completion of use of the terminal. The centralising device is then instructed to install the card on the internet site.

Thus, the invention makes it possible to produce personalised photographic correspondence cards, in which the client is shown in front of a live, actual setting. The client is completely free to insert himself (or not to insert himself) in this natural setting, to select the angle of the view, by means of any means for adjustment of the means for taking the shot, to select his pose, etc. The photographic correspondence card is then dispatched to its recipient via two digital data transmission networks, i.e. a network between the terminal and the centralising device, access to which network is preferably restricted to the interactive terminals and to the centralising device according to the invention, in order to guarantee the confidentiality of the transmission of data, and in particular payment data, and the Internet network between the centralising device and the recipient of the virtual card. The transmission times are extremely low (or even instantaneous). The time required for dispatch of a virtual card thus depends only on the time which elapses between taking the photograph and the remote gathering of the corresponding data by the centralising device via the sender network, on the time for processing of the said data by the said device (virtually instantaneous), and on the time which elapses between the end of this processing and transmission of the virtual card to its recipient by the centralising device, via the recipient network. The time for dispatch of the photographic correspondence cards thus depends on the frequency of the remote gathering and distribution, by the centralising device, of the data relative to the cards produced. The system according to the invention can advantageously involve a plurality (1 to 4) of remote gathering operations and distributions per day. A system of this type is particularly economical (frequencies and lengths of connections to the various networks low), and is thus viable for correspondence cards offered at a low cost. It therefore makes it possible to reduce to a few hours the time for dispatch of a correspondence card.

The virtual cards concerned are optionally integrated simultaneously by the centralising device in a computer page which is composed automatically, and has an access lock known by the client alone (information supplied on the payment ticket, for example). This page is transmitted to an FTP server, in order to be inserted on an Internet site which is accessible for a given time to holders of the aforementioned confidential code.

The invention also relates to a system and a method for production and dispatch of personalised virtual cards, characterised in association by all or part of the characteristics described previously and hereinafter.

Other objects, characteristics and advantages of the invention will become apparent from reading the following description, provided with reference to the attached figures, which represent preferred embodiments of the invention, provided purely by way of non-limiting example. In these drawings:

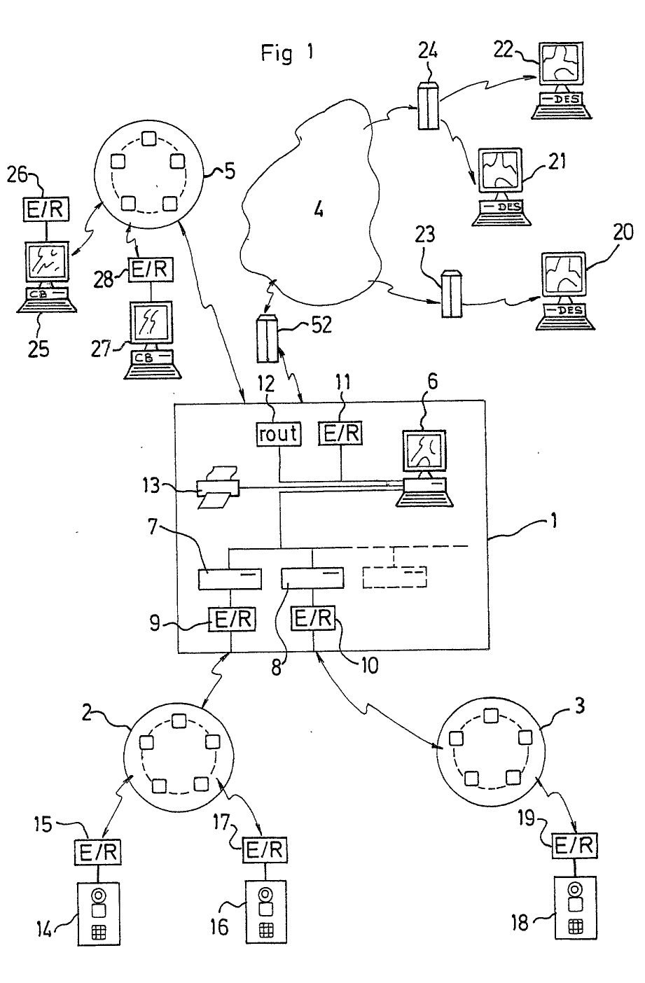

FIG. 1 is a representation of an embodiment of a system according to the invention; and

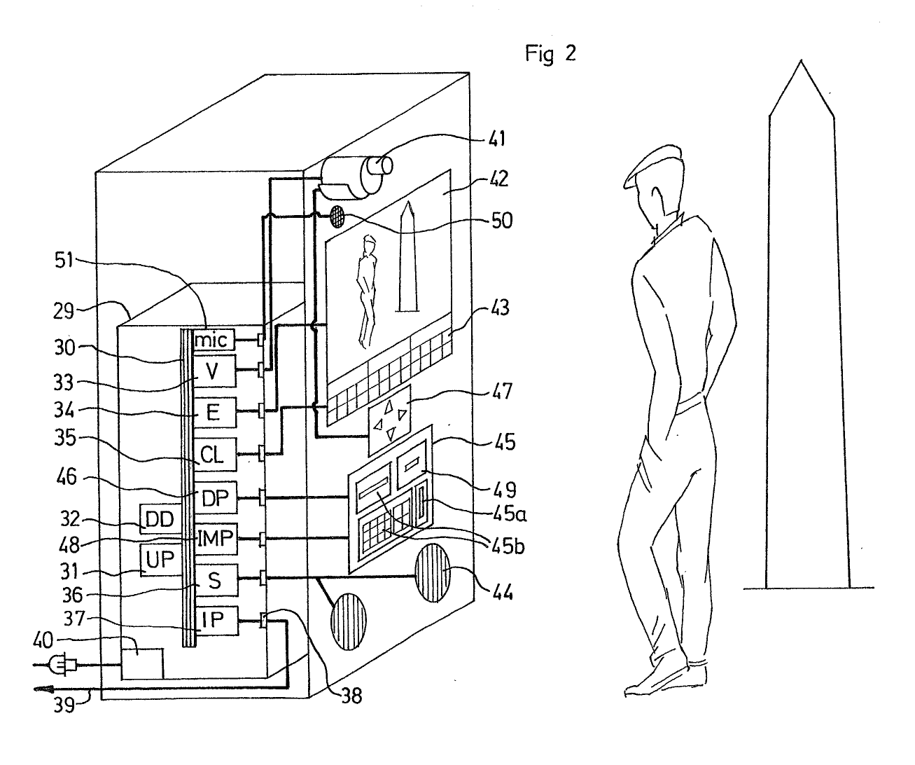

FIG. 2 is a representation of an embodiment of an interactive terminal according to the invention.

FIG. 1 illustrates a method for operation of a centralising device 1 for processing of virtual cards and other data, and of a plurality of terminals 14, 16, 18. It represents a non-limiting example of a digital data transmission network according to the invention, comprising at least one sender network and a recipient network. The sender network comprises a plurality of specific sub-networks 2, 3, which for example use a switched analogue and/or digital telephone network, access to which is limited to the centralising device 1 and to a pre-determined series of terminals 14, 16, 18. The recipient network comprises at least one interconnected worldwide public network 4 of the Internet type, for dispatch of virtual cards to their recipients 20, 21, 22, which are connected to the said network 4 by supplier access servers 23, 24 (this network makes it possible to reach all types of recipients), and a specific network 5, for example a switched analogue and/or digital telephone network, access to which is limited to the centralising device 1 and to the bank terminals 27 and other computers 25 of bank card processing centres.

Each interactive terminal 14, 16, 18 has means 15, 17, 19 for connection to the sender network (i.e. to at least one of the sub-networks 2, 3). These means are preferably two-way in terms of transmission and reception, and, according to the data transmission means to which they are connected (wired or wireless), can consist of a modem, a radiofrequency transmission/reception antenna etc. The terminals 25, 27 of the banks and the bank card processing centres have means 26, 28 for connection to the network 5 which are similar to those of the terminals 14, 16, 18 previously described.

The centralising device 1 for automatic processing of virtual cards and other data comprises a central computer 6, comprising a central unit, a screen and an alphanumerical keyboard. The centralising device 1 also comprises a printer 13, means 11 for connection to the specific network 5 and the Internet 4 (recipient network), comprising for example one or a plurality of modems, and optionally a router 12, which in particular makes it possible to route data packages onto the Internet network 4 in an off-line manner, according to a protocol of the IP type for example. The centralising device 1 accesses the Internet network 4 by means of a separate server device 52, or can itself constitute a server device for access to the said network.

Finally, the centralising device 1 comprises intermediate computers, which are connected to the central computer 6 by a network, known as the local network, and each of which comprises a central unit 7, 8, and means for connection (modems) 9, 10 to the networks 2, 3 (sender network). Each intermediate computer central unit 7 is responsible for managing ten or so terminals 14, 16, which constitute the specific sender network 2 associated with the said intermediate computer. The said central unit 7 has at least one communication software, which is designed to be able to establish direct communication with the interactive terminals 14, 16 which it controls, and to transmit or receive numerical data, which are preferably encoded, according to a pre-determined, known by the said terminals communication protocol. The intermediate computers advantageously have a client role, each terminal 14, 16, 18 constituting a server. On their own initiative, they can thus enter into communication with each of the terminals of their associated network, in order to be able to gather regularly, remotely, the virtual cards produced which are waiting to be dispatched, and the payment data stored in the said terminals. Each central unit 7, 8 of the intermediate computer also has a programme for control of the connection to the local network.

In addition to the habitual operative system software and the aforementioned programmes for control of the modem 9, 10 and for control of the connection to the local network, each central unit 7, 8 of the intermediate computer comprises:

an initialisation file (.ini for example), which contains the specifications of the interactive terminals which are associated with it by means of the network 2, 3 (name of the terminal, number of the terminal, user name and password for the telephone connection, user name and password for the server programme implanted in the terminal, specific name of the associated intermediate computer); and

an executable file (.exe), known as the interrogation programme, controlled by a clock. This makes it possible to load in the preceding file the specifications of the interactive terminals which are alloted to it. At a pre-determined time, the interrogation programme calls these terminals one after another. When communication has been established, for each of the terminals it searches for the existence and number of files which contain photographic data, client data and payment data. Depending on their nature, these data are recorded in three types of files, i.e. .txt files for texts, for example (client data and/or payment data), .jpg files for example for images (photographic data), and .wav files for example for sound (client data). The interrogation programme copies the files detected, and, via the local network, transfers the copied files retrieved to three directories in the central computer 6, corresponding to the three types of files previously retrieved. In passing, it allocates to each file a name which identifies at least the intermediate computer via which it has passed, the terminal from which it has come, its order number in this terminal, and a numerical identifier for the transfer operation. Verification procedures for errors and re-running of transfers interrupted accompany the entire operation. In the event of errors or untimely interruptions of the communication, the operation is re-run either partially or fully. After three unsuccessful attempts, an error message is addressed to the central computer 6, and is displayed on its screen, and/or transmitted to the printer 13. In parallel, in a log file for example, the interrogation programme records information relating to the development of the various preceding operations (date and time of execution, result, and, if applicable, fatal errors, interruptions, abnormal operations, etc). Some of this information can be transmitted to the printer 13. When transfer of the files copied has taken place and has been verified, the interrogation programme erases the initial files contained in the memory of the terminal.

The central computer 6 has communication software which is designed to be able to establish direct communication with the server device 52, according to a communication protocol of the TCP/IP type known to the recipients 20, 21, 22 of the virtual cards. It also has specific communication software which makes it possible to establish direct communication with the various computers connected to the specific network 5, for transmission of payment data, which are preferably encoded. Finally, it has a specific programme for management of the local network.

In addition to the habitual operative system software and the aforementioned programmes and software, the central computer 6 contains:

an executable file (.exe), which extracts the bank data from the payment data contained in the text files transferred by the series of intermediate computers, and converts the said data into a canonical form known of at least one programme used by the bank system(s) (Win Vad ® for example);

at least one programme of the Win Vad ® type, which transmits bank data to a bank card processing centre, receives in return the debit authorisations or refusals for each of the bank operations (a bank operation corresponding to a virtual card), and transmits the bank data considered valid to the remote collection centre of the bank(s) network(s);

an executable file (.exe), which analyses the data supplied by the Win Vad ® programme, after verification by the bank card processing centre has taken place, erases from the memory of the central computer 6 the photographic data, the client data and the payment data corresponding to bank cards which are not authorised, creates a Web page for each of the virtual cards which are designed to be displayed on an Internet site with coded access for a given time, names each Web page created with the code name shown on the ticket issued to the client of the terminal, and creates an e-mail message for each of the virtual cards, of which the electronic address of the recipient has been supplied by the client. All of the Web pages created are copied by an FTP protocol onto an Internet site, the address of which is indicated on the ticket of the clients, and each e-mail created is sent via the Internet to its recipient; and

an accessory programme, which receives in return and classifies the e-mail messages, the addresses of which have been found to be incorrect or non-existent, and records them in case there is a complaint from the client.

FIG. 2 represents an example of an interactive terminal 14, 16, 18. The computer resources of the terminal comprise a central computer unit, a schematic example of the structural architecture of which is illustrated in the said figure (the architecture is that of a conventional microcomputer).

The central unit comprises at least one backplane bus 30, to which the various operative cards 31-37, 46, 48 and 51 of the central unit 29 are connected. A microprocessor motherboard 31 controls the general operation of the unit. Conventionally, each microprocessor of the motherboard 31 is associated with read-write memories and read-only memories, and other corresponding associated components. The unit comprises at least one refresh memory in the form of at least one hard disc 32. Inter alia, the hard disc 32 comprises memory spaces which are reserved preferentially for storage of client data, photographic data, and payment data to be transmitted. In addition to the conventional operative system programmes and the modem control programmes (server programme) the hard disc 32 additionally comprises a specific programme for execution of interactive steps, for the purpose of taking a shot of a client, and production of a virtual card, known as the programme for production of the virtual card, which is described in greater detail hereinafter. A card 33 makes it possible to pilot a digital video camera 41; a card 34 makes it possible to control a display screen 42; a card 35 controls the means for input of client information 43 (alphanumerical keyboard or touch screen); a card 36 makes it possible to control a sound-emission device 44 (loud speakers); a card 46 controls a payment device 45; a card 48 pilots means 49 for printing; and a card 51 controls a sound-recording device 50.

A connection card 37 (modem card in the case of a connection by telephone line, or other network card) makes it possible to connect the central unit of the terminal to a first data transmission line (switched telephone line) connected to the network 2, 3. The central unit 29 is in the form of a closed case provided with at least one external connection 38 to the said telephone line. It will be appreciated that the connection card 37, which is internal and directly connected to the bus 30 in the example illustrated, can also be in the form of an external device.

Finally, the central unit is permanently switched on, by means of a electrical supply lead 40, which is constantly connected to an electricity distribution network.

The terminal 14, 16, 18 illustrated in FIG. 2 also comprises a digital video camera 41, a display screen 42, a touch screen 43 (which can be the same as the display screen 42), or an alphanumerical keyboard which allows the client to input the client data, loudspeakers 44 by means of which there are optionally broadcast the operative instructions for the interactive terminal and/or the countdown which defines the time allowed to the client before the shot is taken, a microphone 50 to record information supplied by the client, such as the electronic address of the recipient of the virtual card and/or an accompanying message for the said card, a payment device 45 comprising a bank card reader 45b, which is designed to read bank cards with an electronic chip (cards with a confidential code) and/or a bank card reader 45a, which is designed to read any type of card (including cards without an electronic chip), and means 49 for printing.

The terminal also comprises means 47 for adjustment of the position of the camera, which are accessible by the client, and allow the latter to select the angle of the view of the monument or landscape which acts as a background. These means for adjustment can be manual or electronic. The possibilities of positioning of the camera 41 can be, or are not, limited to given vertical and horizontal angular sectors.

The two screens 42 and 43, the loudspeakers 44, and the sound-recording device 50 constitute a human interface for dialogue with the client. The instructions for use of the terminal are thus emitted by the display screen 42 and/or by the loudspeakers 44, before any use is made of the terminal and/or during use of the latter. They can also be painted onto the cabinet of the terminal, or printed on a plate attached to the latter. The information transmitted to the client comprises in particular:

the price of a virtual card. According to an advantageous and economical embodiment of the invention, taking a shot of a client gives rise to the creation of a virtual card (a single image and a single recipient). The price is then fixed. The possibility of addressing the same card to another recipient is optionally left to the choice of the client, provided that the latter pays once again, with the same bank card, for the amount of a virtual card, and selects the option which allows him to re-use the card previously produced. According to another embodiment of the invention, taking a shot of the client gives rise to production of a plurality of virtual cards (a single image but a plurality of recipients). The price of the said card then depends on the number of recipients. As a variant or in combination, the price of a virtual card can also vary according to the existence of an accompanying message and its length, placing the card for a pre-determined time on an Internet site with access which is controlled by a code, etc.;

the method of payment and the instructions for use of the payment device 45;

the various steps of the process for taking a shot;

the approximate position of the client when the shot is taken, making it possible to obtain optimum framing of the latter; and

the manner of using the means 47 for adjustment of the orientation of the camera 41, making it possible to pivot the latter in order to personalise the photograph further still, and/or to prevent any unfavourable light from behind, etc.

The touch screen 43 and/or the sound-recording means 50 allow the client to input certain client data, such as the electronic address of the recipient of the virtual card, his agreement or refusal concerning placing of the virtual card on an Internet site (which is or is not protected), this option being selected by the client if he does not know the address of the recipient, or if he wishes. The client can also input an accompanying message for the virtual card, and/or select from amongst pre-recorded messages, or finally choose not to have the virtual card accompanied by a message. The messages may or may not be limited in terms of number of characters, pasted onto the photograph of the client, or simply attached thereto.

At each payment, the payment device 45 is designed to generate payment data comprising for example the amount, the date, the time and place of the operation, the number of the client's bank card, the name, details and reference of his bank, etc. Part of these data is transmitted to the banks concerned and/or to a bank card processing centre, and part is printed out on a ticket which is issued immediately to the client.

In particular, the operation of the terminal is controlled by a programme for production of a virtual card, as previously described. This programme activates the camera 41 if the latter was on stand-by, transmits to the display screen 42 the images filmed by the camera 41, receives the client data (electronic address of the recipient, accompanying message for the virtual card, etc), receives the bank data obtained from presentation of a bank card by the client into the means for payment (device involving passage for the cards as a whole, and/or device with code for bank cards with electronic chips), transmits to the loudspeakers 44 and to the display screen 42 a countdown of about ten seconds before the shot is taken, thus allowing the client to take up the position he chooses opposite the camera, receives the photographic data obtained from taking the shot at the end of the countdown, and transmits to the display screen 42 the said shot, which will continue to be displayed on the screen for a few seconds in order to allow the client to see the virtual card created, and optionally to decide whether he wishes to send the same card again to another recipient. It should be noted that taking the shot selected for the creation of the virtual card can be a selection from amongst various photographs taken by the means for taking a shot during the countdown. In this case, the photographs proposed are displayed on the display screen at the end of the countdown, and the client indicates his choice by means of the human interface. The display screen displays the image selected, and the corresponding photographic data are recorded. The screen can also display the address(es) of the recipient(s) of the card and/or the accompanying message, and/or the response by the client concerning putting the said virtual card on the Internet, for final verification and confirmation by the client. The programme for production of the virtual card records all the information received on its hard disc in coded form, in text, image or sound files. This programme also controls function keys such as keys which make it possible to change the language in which the instructions for use are issued, a help key which makes it possible to read or re-read the instructions for use of the terminal, keys which make it possible to select the type of destination of the virtual card (e-mail address and/or Internet site), and keys to start recording a sound message, to listen to the said message, etc.

It will be appreciated that the invention can form the basis of many variants compared with the embodiments previously described and illustrated in the figures.

1. A system for production and dispatch of virtual photographic correspondence cards, known as virtual cards, comprising at least one interactive terminal (14, 16, 18), which is located at a site accessible to a user, known as the client, of the said terminal, each interactive terminal (14, 16, 18) comprising computer resources (29, 30, 31, 32), means for taking shots (41), means for payment (45), means for connection (15, 17, 19, 37, 38) to a network (2, 3) for transmission of digital data, and a human interface (42, 43, 44, 50), the said means, resources and interface as a whole being designed to allow a shot to be taken, and to generate and store digital data relating to the shot, known as photographic data, digital data relating to the payment, known as payment data, and digital data relating to information provided by the client, by means of the human interface, known as client data, at least some of the client data and the photographic data forming the virtual card,
wherein the said system comprises:
at least one digital data transmission network (2,3), known as the sender network, to which each interactive terminal can be connected;
at least one digital data transmission network (4, 5), known as the recipient network;
the said sender and recipient networks being designed to be able to transmit digital photographs or images and/or text and/or sound; and
at least one centralising computer device (1), for automatic processing of the data stored by each terminal, known as the centralising device, comprising computer resources (6, 7, 8) and means (9, 10, 11) for connection to the sender (2, 3) and recipient (4, 5) networks, which, via the sender network (2, 3), can receive at least some of the photographic data, the client data and the payment data stored in each interactive terminal, record the data received, and address at least part of them, via the recipient network (4, 5).

2. A system as claimed in claim 1, wherein the sender network (2, 3) is preferably a specific network which can be accessed only by each terminal (14, 16, 18) and each centralising device (1), and the recipient network is at least partially a public network (4).

3. A system as claimed in claim 1 or claim 2, wherein the sender (2, 3) and recipient (4, 5) networks comprise cabled and/or wireless data transmission means, each interactive terminal (14, 16, 18) and each centralising device (1) having means for connection (15, 17, 19, 9, 10, 11) which are adapted to the data transmission means to which they are connected.

4. A system as claimed in any one of claims 1 to 3, wherein the means (41) for taking shots of at least one interactive terminal (14, 16, 18) are fitted on the said terminal such that the client located in the vicinity of the terminal in a pre-determined space, is in the field of vision of the said means.

5. A system as claimed in any one of claims 1 to 4, wherein the means (41) for taking shots of at least one interactive terminal (14, 16, 18) are fitted such as to be mobile on the terminal, and comprise means (47) for adjustment accessible by the client, which are designed to make at least part of the said means (41) for taking shots pivots horizontally and vertically.

6. A system as claimed in any one of claims 1 to 5, wherein the human interface of at least one interactive terminal (14, 16, 18) comprises an alphanumerical keyboard and/or a touch screen (43), for acquisition of the client data.

7. A system as claimed in any one of claims 1 to 6, wherein the human interface of at least one interactive terminal (14, 16, 18) comprises a sound-recording device (50), for acquisition of client data known as client sound data, at least one centralising device (1) being designed to receive at least part of the said data via the sender network (2, 3), to record the client sound data acquired, and to address at least part of them via the recipient network (4, 5).

8. A system as claimed in any one of claims 1 to 7, wherein the human interface of at least one interactive terminal (14, 16, 18) comprises a display screen (42) and/or a sound-emission device (44).

9. A system as claimed in any one of claims 1 to 8, wherein the human interface of at least one interactive terminal (14, 16, 18) comprises means (49) for printing at least part of the payment data and/or the client data, for immediate distribution of a ticket to the client.

10. A system as claimed in any one of claims 1 to 9, wherein the means for payment (45) of at least one interactive terminal (14, 16, 18) comprise a bank card reading device (45a, 45b), at least one centralising device (1) being designed to transmit at least part of the payment data gathered to a bank card processing centre and/or to the banks concerned.

11. A system as claimed in any one of claims 1 to 10, wherein the human interface (42, 44) and/or the means for taking shots (41) of at least one interactive terminal (14, 16, 18) are designed to remain active between two usages of the said terminal.

12. A system as claimed in any one of claims 1 to 11, wherein at least one interactive terminal (14, 16, 18) comprises sensor means which are designed to detect any movement in a given perimeter in the vicinity of the terminal, the means (41) for taking shots and/or the human interface (42, 44) of the said terminal being designed to be activated or put on standby, between two usages of the said terminal, under the control of the sensor means.

13. A system as claimed in any one of claims 1 to 12, wherein at least one centralising device (1) comprises:
an internal digital data transmission network, known as the local network, which is designed to be able to transmit digital photographs or images and/or text and/or sound;
at least one computer, known as an intermediate computer, comprising means for connection to the sender network (9, 10), means for connection to the local network, and a central unit (7, 8) which is provided with software and specific programmes designed to make it possible to receive, via the sender network (2, 3), and to transmit to a computer (6) known as the central computer, via the local network, at least part of the photographic data, the client data and the payment data stored in a series of pre-determined interactive terminals (16, 18);
a central computer (6), comprising means for connection to the recipient network (11), means for connection to the local network, and a central unit which is provided with specific software and programmes designed to make it possible to receive the data transmitted by each intermediate computer, and to address at least part of the said data via the recipient network (4, 5), according to transmission protocols determined according to the recipients of the said data.

14. A method for production and dispatch of virtual photographic correspondence cards, known as virtual cards, implemented in a system as claimed in any one of claims 1 to 13, and comprising a step for production of the virtual card by an interactive terminal (14, 16, 18), comprising:
recording, in the form of client data, of a destination of the virtual card, the said destination being supplied by a client of the terminal by means of the human interface (43, 50);
recording of payment data, generated by the means for payment (45), further to payment for the virtual card by the client, by means of the said means for payment;
taking of a shot, according to a process comprising a countdown time before the shot is taken, a shot by the means for taking a shot (41), and recording of photographic data generated by the shot;
wherein the said method comprises a step of dispatch of the virtual card, in which:
at least part of the client data and the photographic data is transmitted, via the sender network (2, 3), to the centralising device (1);
the data received by the said device (1) are recorded, at least part of the said data forming the virtual card; and
the virtual card is addressed, via the recipient network (4, 5), according to the destination (20, 21, 22) provided by the client.

15. A method as claimed in claim 14, wherein the process for taking the shot is triggered by the means (45) for payment, further to payment for the virtual card by the client.

16. A method as claimed in claims 14 and 15, implemented in a system in which at least one interactive terminal has sound-recording means (50), comprising:
storage of client sound data generated by recording of sound during production of the virtual card;
transmission to the centralising device (1), via the sender network (2, 3), of at least part of the client sound data;
receipt and recording of the said data by the centralising device (1), at least part of the client sound data received forming a vocal and/or sound message to accompany the virtual card; and
dispatch to the recipient (20, 21, 22) of the virtual card, via the recipient network (4), of the vocal and/or sound message, as an integral part of the said virtual card.

17. A method as claimed in any one of claims 14 to 16, wherein at least part of the payment data is transmitted, via the sender network (2, 3), to the centralising device (1), and is recorded by the said centralising device.

18. A method as claimed in any one of claims 14 to 17, wherein the client data and/or the photographic data and/or the payment data generated by the interactive terminal (14, 16, 18) during production of the virtual card are compressed and/or coded before being transmitted to the centralising device (1), the said data being decompressed and/or decoded after being received by the centralising device (1).

19. A method as claimed in any one of claims 14 to 18, wherein the centralising device (1) verifies the intactness of the transmission of client data and/or photographic data and/or payment data gathered.

20. A method as claimed in any one of claims 14 to 19, wherein the centralising device (1) classifies the digital data gathered according to their nature, and labels the said data according to parameters relating to their interactive terminal of origin (14, 16, 18) and their transmission to the centralising device (1).

21. A method as claimed in any one of claims 14 to 20, wherein the client data and/or the photographic data and/or the payment data transmitted to the centralising device (1), are erased from the interactive terminal (14, 16, 18).

22. A method as claimed in any one of claims 14 to 21, wherein at least part of the payment data gathered by the centralising device (1) relative to payments made by bank card at the interactive terminals (14, 16, 18) comprising a suitable payment device (45), is addressed, via the recipient network (5), to a bank card processing centre and/or to the banks concerned.

23. A method as claimed in claim 22, wherein a virtual card corresponding to payment data which are not considered valid by the bank card processing centre is not addressed to its recipient (20, 21, 22), the corresponding photographic data, the client data and the payment data being erased from the centralising device (1).

24. A method as claimed in any one of claims 14 to 23, implemented in a system comprising at least one interactive terminal (14, 16, 18), which has means (49) for printing of data, wherein it comprises printing, on a ticket, of at least part of the client data and/or payment data, and immediate distribution of the said ticket to the client.

25. A method as claimed in any one of claims 14 to 24, wherein the centralising device (1) triggers periodically and automatically a connection to the sender network (2, 3), for interrogation of each interactive terminal (14, 16, 18), and gathers remotely in batches, via the said sender network (2, 3), at least part of the client data, the photographic data and/or the payment data detected in each terminal (14, 16, 18).

26. A method as claimed in any one of claims 14 to 25, wherein the centralising device (1) triggers periodically and automatically a connection to the recipient network (4, 5), for dispatch in batches of the virtual cards gathered, to their recipient (20, 21, 22), and/or for dispatch in batches of the payment data relative to payments made by bank card to a bank card processing centre (25), and/or to the banks concerned (27).

27. A method as claimed in any one of claims 14 to 26, implemented in a system according to claim 17, wherein:
each intermediate computer (7, 9) triggers periodically and automatically a connection to the sender network (2), interrogates consecutively each terminal (14, 16) in the series of pre-determined interactive terminals, which it controls, gathers remotely, verifies, classifies and labels at least part of the client data, the photographic data and the payment data detected in the said terminals, and transmits the data gathered remotely to the central computer (6), via the local network; and
the central computer (6) triggers periodically and automatically a connection to the recipient network (4, 5), and addresses in batches to their recipient (20, 21, 22) the virtual cards gathered, and/or addresses in batches to a bank card processing centre (25) and/or to the banks concerned (27) the payment data gathered relative to payments made by bank card.

28. A method as claimed in any one of claims 14 to 27, implemented in a system in which the recipient network (4) is at least partially the Internet network, wherein it comprises installation of the virtual card on an Internet site, for a given time, with the agreement of the client.
